(19) United States
(12) Patent Application Publication
(10) Pub. No.: US 2026/0023999 A1
(43) Pub. Date: Jan. 22, 2026

(54) EFFICIENT NEURAL NETWORK PRETRAINING USING TENSOR NETWORKS

(71) Applicant: IonQ, Inc., College Park, MD (US)

(72) Inventors: Jonathan MEI, Jersey City, NJ (US); Sayonee Ray, White Plains, NY (US)

(21) Appl. No.: 19/265,968

(22) Filed: Jul. 10, 2025

Related U.S. Application Data
(60) Provisional application No. 63/672,585, filed on Jul. 17, 2024.

(51) Int. Cl. G06N 10/60; G06N 3/084

(52) U.S. Cl. CPC G06N 10/60; G06N 3/084

(57) ABSTRACT

Aspects of the present disclosure relate generally to systems and methods for pretraining a neural network. The method includes training the neural network configured to execute a type of inference. The method includes initializing a current parameter represented by T+U×V^{T}. The T is a reduced structured representation of the current parameter, the U is a low-rank factor corresponding to a representation of a first portion of the current parameter with a dimension of n×r, and the V^{T} is a low-rank factor corresponding to a representation of a second portion of the current parameter with a dimension of r×n. The method also includes projecting a full gradient G into a lower dimensional subspace. The method further includes updating the current parameter to an updated parameter represented by T+U′×V^{T} and executing the type of inference on at least in part on a quantum computer based on the re-trained neural network.

### CROSS REFERENCE TO RELATED APPLICATIONS

This application claims priority to U.S. Patent Provisional Application No. 63/672,585, filed Jul. 17, 2024, the contents of which are hereby incorporated by reference in its entirety.

### TECHNICAL FIELD

Aspects of the present disclosure relate generally to systems and methods for use in the implementation, operation, and/or use of pre-training neural networks using tensor networks.

### BACKGROUND

Artificial intelligence (AI) and machine learning (ML) techniques are being adopted for use in performing an increasing variety of tasks across a wide variety of industries. While such usage may provide many advantages, there are also various barriers to practical usage. For example, a significant issue is the energy consumption required for training these large AI models. This energy consumption for training these large AI models is untenable. In addition, as applications become more complex, the large AI models will also become larger and more structured.

It is therefore important to develop new techniques that improve the design, implementation, and functionality of large AI models by improving training techniques.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

This disclosure describes various aspects of techniques for training large AI models while maintaining accuracy. Specifically, the present disclosure provides a method for optimizing neural network parameters represented in a hybrid form combining a tensor train operator and low-rank factors. In this approach, a parameter is expressed as T+U·V^{T}, where T is a tensor train operator (TTO) with a low bond-dimension, representing a matrix of dimension (m, n). The combined quantity T+U×V^{T} also conforms to a shape of (m, n) and is treated as a unified parameter during backpropagation. This treatment enables computation of the full gradient G with respect to the entire parameter, thereby preserving optimization dynamics that closely resemble those observed in conventional full-rank training methods. Simultaneously, the use of tensor train and low-rank components reduces both the memory footprint of the parameter representation and the associated optimizer state, facilitating more efficient training without compromising performance.

In some aspects of the present disclosure, a method for pretraining a neural network by casting weight matrices as tensor train operators is described. The method includes initializing a current parameter represented by T+U×V^{T} to determine a behavior of the neural network. The T is a tensor train operator with a low bond-dimension representing a m×n matrix. The U is a low-rank factor corresponding to a dimension of m×r. The V^{T} is a low-rank factor corresponding to a representation of a second portion of the current parameter with a dimension of r×n. The method also includes projecting a full gradient G into a lower dimensional subspace by treating the T+U×V^{T} as a single parameter during backpropagation. The lower dimensional subspace may correspond to a dimension of m×r for operating an optimizer. The method also includes updating the current parameter to an updated parameter represented by T+U′×V^{T} to minimize an error between a predicted output and an actual target. The U′ may be generated based at least in part on inputting the full gradient G into the optimizer and the U from the current parameter. The method further includes re-training the neural network using the updated parameters. The method further includes executing the type of inference on at least in part on a quantum computer based on the re-trained neural network.

In some aspects of the present disclosure, a system of pretraining a neural network to execute a type of inference is described. The system includes at least one processor and a memory including instructions that, when executed by the at least one processor, cause the system to: initialize a current parameter represented by T+U×V^{T} to determine a behavior of the neural network. The T is a tensor train operator with a low bond-dimension representing a m×n matrix. The U is a low-rank factor corresponding to a dimension of m×r. The V^{T} is a low-rank factor corresponding to a representation of a second portion of the current parameter with a dimension of r×n. The memory also includes instructions to also cause the system to project a full gradient G into a subspace by treating a sum of the T+U×V^{T} as a parameter during backpropagation. The subspace corresponding to a dimension of m×r for operating an optimizer. The memory also includes instructions to also cause the system to update the current parameter to an updated parameter represented by T+U′×V^{T} to minimize an error between a predicted output and an actual target. The U′ is generated based at least in part on inputting the full gradient G into the optimizer and the U from the current parameter. The memory also includes instructions to further cause the system to re-train the neural network using the updated parameters. The memory also includes instructions to further cause the system to execute the type of inference on at least in part on a quantum computer based on the re-trained neural network.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions in a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4 illustrates an example of a training iteration for a single matrix-valued parameter using an optimizer.

FIG. 5 illustrates an example of another training iteration for a single matrix-valued parameter using a parameter-efficient fine-tuning method.

FIG. 6 illustrates an example of another training iteration for a single matrix-valued parameter using a compressed optimizer state.

FIG. 7 illustrates an example of a training iteration for a single matrix-valued parameter using tensor networks in accordance with aspects of this disclosure.

FIG. 8 illustrates a pretraining method for neural networks using tensor networks in accordance with aspects of this disclosure.

FIG. 9 illustrates an example of a QIP system in accordance with aspects of this disclosure.

Like reference numbers and designations in the various drawings indicate like elements.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

State of the art artificial intelligence (AI) models are massive. For example, some AI model variants have massive parameter counts in the hundreds of billions. For these AI models, there are generally two phases: creating the AI model (c.g., training) using weights, training data, objectives, a model, and then utilizing the trained AI models (e.g., inference) to make predictions based on new data and updated weights from the training. It is computationally expensive to train and use these large models even after training so reducing their size is of great practical interest.

Much of the success of machine learning and training neural networks is from building larger and larger neural networks. The neural network is the machine learning (ML) model that is trained to minimize the value of an objective function when evaluated on training data (e.g., referred to as objective function ‘f’ and also known as the loss). A neural network has many large weights that require lots of memory and incur hefty computation costs. The larger neural networks perform better on various tasks, but also makes them much more expensive to use since larger models take more storage space, which makes them harder to distribute. In addition, larger neural networks also take more time to run and can require more expensive hardware. These are all concerns that should be considered when training and building large neural network models for real-world applications.

Accordingly, a current state of the art ML models has tremendous computational and storage requirements. The computational and storage requirements generally come from two phases: training and inference. In addition, the training can be further divided into pre-training and fine-tuning. During training of the neural network, there are several large consumers of memory including the parameters, gradients of the parameters, and optimizer state. It should be noted that there are activations and other miscellaneous intermediate data that needs to be kept in memory as well, but the main savings come from reducing the parameters, gradients of the parameters, and optimizer state.

Reducing memory size for pretraining neural networks aims to address several critical goals, particularly in the context of scalability, efficiency, and accessibility. The benefits to reducing the memory requirements during pretraining while also minimizing loss in accuracy or performance affect many key objectives including resource efficiency, cost reduction, speed and scalability, deployability, and robustness/maintenance.

First, by reducing the memory footprint, models can be trained on less powerful hardware, which makes deep learning more accessible to researchers and practitioners without access to high-end graphics processing unit (GPUs) or tensor processing units (TPUs). Smaller models also generally consume less energy, contributing to more sustainable and cost-effective AI development.

Second, reduced memory usage can lower the cost associated with cloud computing resources such as virtual machines and storage. This may be particularly important for large-scale pretraining tasks that require substantial computational resources over extended periods. Efficiency memory utilization can also reduce ongoing operational expenses, including electricity and cooling for data centers.

Third, smaller memory requirements often lead to faster data throughput and reduced latency during training, enabling quicker iterations and faster convergence. Efficient memory usage allows for scaling up models to larger datasets and more complex architectures without hitting memory constraints and facilitating the training of more sophisticated models.

Fourth, reducing memory size is crucial for deploying models on edge devices with limited memory, such as smartphones, IoT devices, and embedded systems. Memory-efficient models can be deployed in real-time applications where rapid inference is critical, such as autonomous driving, real-time language translation, and interactive AI systems.

Fifth, smaller models are often easier to debug and maintain. They may have fewer parameters to tune, and issues related to overfitting or model complexity can be more straightforward to address. Managing versions and updates of smaller models is typically more straightforward, which can be beneficial for continuous integration and deployment pipelines.

By focusing on reducing the memory size for pretraining neural networks, the overall goal is to make AI development more cost-effective, scalable, and accessible, ultimately driving broader adoption and innovation in the field.

To this end, it would be advantageous to reduce the memory requirements and compute footprints of parameters when training AI models while still maintaining efficiency and accuracy of the training. For example, it would be advantageous to reduce the cost of large consumers of memory such as parameters, gradients of parameters, and optimizer state using tensor networks during pre-training. Specifically, the present disclosure describes a system and process to reduce computational and memory savings during training of neural networks without sacrificing the quality of the trained models by using tensor network.

As described herein, trapped atomic ions is an example of quantum information processing approach that has delivered fully programmable machines. In trapped ion QIP, interactions may be naturally realized as extensions of common two-qubit gate interactions. Therefore, it is desirable to use entangling gates for efficient (e.g., reduced gate count) quantum circuit constructions to implement interactions in trapped ion technology. One particular interaction available in the use of trapped ions for quantum computing is the so-called Mølmer-Sørensen (MS) gate, also known as the XX coupling or Ising gate. To achieve computational universality, the Mølmer-Sørensen gate (either locally addressable or globally addressable) is complemented by arbitrary single-qubit operations, for example.

Using these principles, the exemplary system and method described herein provides for implementing a pretraining method for a neural network using tensor networks. In particular, the system and method include reducing the optimizer state memory requirement while keeping parameters at their original size. Specifically, the tensor networks allow cheaper pre-training as compared to other methods by casting weight matrices as tensor train operators (TTOs, or matrix product operators) to yield much lower memory and compute footprint of the parameters. In addition, since the TTO geometry has a natural translation onto quantum circuits, inference can be performed in part on a quantum computer.

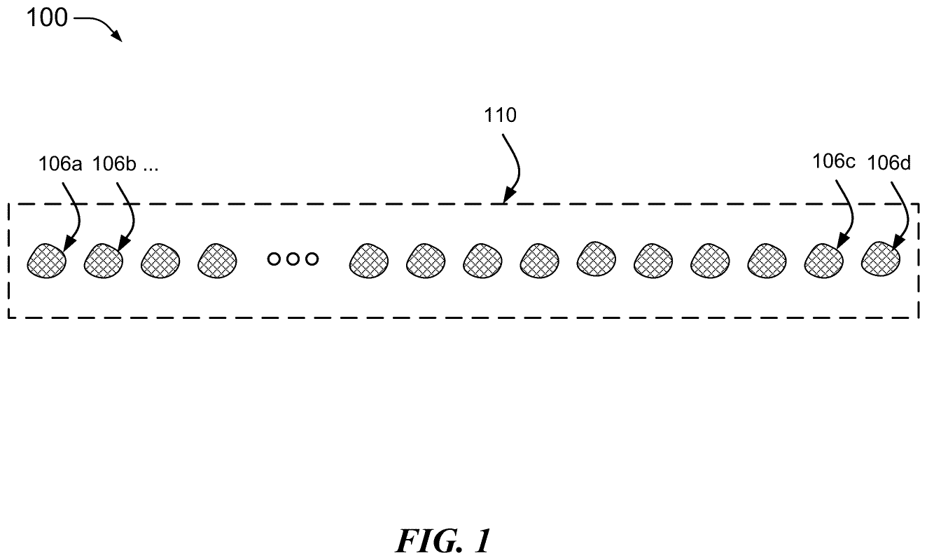

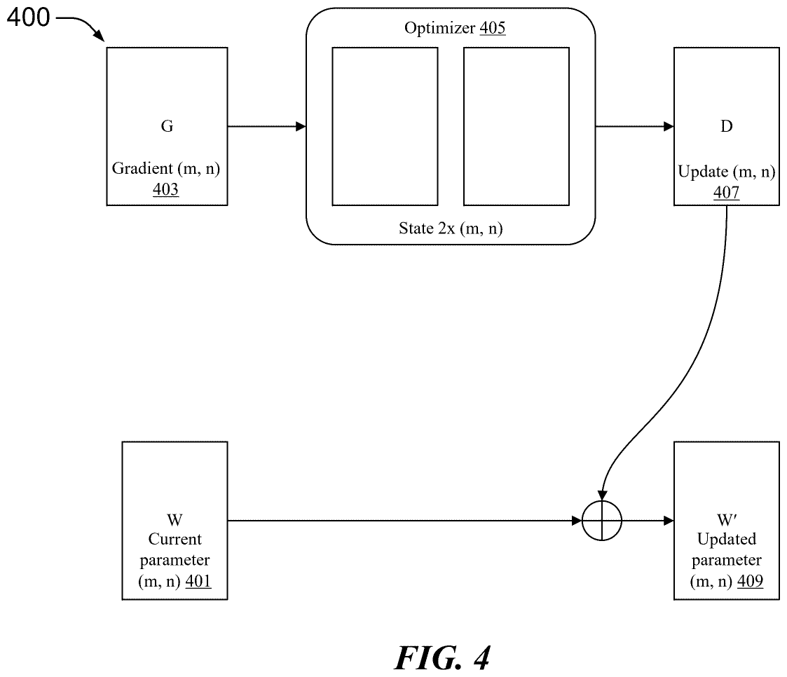

Solutions to the issues described above are explained in more detail in connection with FIGS. 1-9, with FIGS. 1-3 and 9 providing a general disclosure of QIP systems or quantum computers, and more specifically, of atomic based QIP systems or quantum computers, FIGS. 4-8 provide descriptions and examples of training large AI models while maintaining accuracy, in accordance with various example aspects of the present disclosure.

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

Atomic quantum computers can include array(s) of atoms or ions trapped, for example, inside a vacuum chamber. A size and dimensionality of atomic arrays may vary.

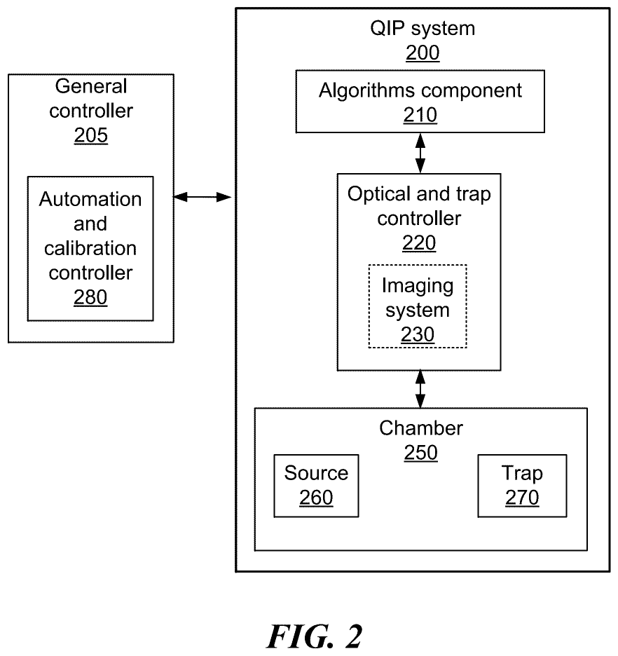

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap may be referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to ytterbium ions, barium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

The chain 110 of ions 106 may be part of a QPU, that is, the chain 110 of ions 106 may be part of a processing engine or processing core of a QIP system. When any one of the ions 106 is capable of being connected to any other ion 106 in the chain 110, the chain 110 is considered to be fully connected, and thus, it can be used to implement a fully connected QPU. Fully connected QPUs need not be limited to atomic-based QIP systems.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (c.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., CCD camera) or other type of detection device (c.g., PMT) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using one or more of the general controller 205, the automation and calibration controller 280, the optical and trap controller 220, and the chamber 250.

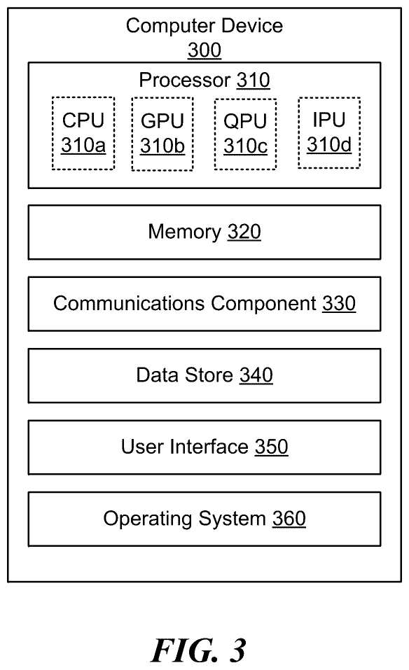

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system capable of performing quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (c.g., artificial intelligence or Al processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies. One or more of the QPUs 310c may be fully connected QPUs in accordance with aspects of this disclosure.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

The present disclosure may describe methods and systems implemented on ion traps in FIGS. 1-3 and 9 for illustrative purposes only, it should be noted that the methods and systems described in the present disclosure may be applied to other quantum computing technologies.

Thus, the systems and methods described herein are configured to implement a quantum circuit for pretraining a neural network using a tensor network in an exemplary aspect. For example, a native gate set is a set of quantum gates that can be physically executed on hardware computing systems (c.g., FIGS. 2-3) by addressing ions (e.g., the exemplary ion chain in FIG. 1) with resonant lasers via stimulated Raman transitions. The angle θ can be defined by the amount of X-rotation where single-qubit gates can be rotated along different axes on a Bloch sphere and/or as rotations along a fixed axis while rotating the Bloch sphere itself. In an exemplary aspect, the rotations can be physically implemented as Rabi oscillations that are made with a two-photon Raman transition to drive the plurality of qubits, such as the ion chain shown in FIG. 1, for example, on resonance using a pair of lasers in a Raman configuration that can be implemented by the optical and trap controller 220, for example. Moreover, the ranges can be controlled by varying the duration of the laser pulses of the Raman configuration.

In connection with the systems described in FIGS. 1-3 and 9, a technique or method for a training method for a neural network using a tensor network is described. Specifically, the present disclosure describes a method of casting weight matrices as TTOs to yield lower memory requirements and compute footprints of the parameters. The systems described in FIGS. 2, 3 and/or 9 may be used to control various aspects of the QIP system as described below.

In some examples, the present disclosure describes a technique of pre-training a neural network by reducing optimizer state memory during training while keeping parameters at their original size. The optimization includes representing a parameter using a particular matrix that is represented by smaller core components including low-rank factors but appear as a whole matrix during back propagation. It is advantageous to use tensor networks to perform cheaper pre-training to yield much lower memory and compute footprint of the parameters. In addition, since the TTO geometry has a natural translation onto quantum circuits, inference can be performed in part on a quantum computer.

As mentioned above, pretraining neural networks using tensor networks is one approach to reduce the computational and storage requirements of pre-training by reducing large consumers of memory.

FIG. 4 illustrates an example of a training iteration for a single matrix-valued parameter using an optimizer. Example 400 of FIG. 4 shows a typical training iteration for a single matrix-valued parameter using an optimizer such as Adaptive Moment Estimation with Weight Decay (AdamW).

The matrices all have a dimension shape m×n and are shown as rectangles in FIG. 4. The current parameter W 401 is updated in-place to updated parameters 409 by using the same address in memory. It should be noted that the update 407 only materializes briefly so it is considered negligible. The gradient 403 and optimizer 405 states show additional memory required during the duration of training. In addition, there may be methods of reducing the duration that the gradient 403 needs to stay in memory by consuming it as soon as it is produces. However, this introduces additional complexity to the training and is beyond a “standard” setup.

Initially, the current parameter W 401 are initialized with random values. In each training iteration, a forward pass is executed where the matrix of the current parameter W 401 is used in the computation of the model's output. Next, a loss L is computing using a loss function, which measures the difference between a predicted output and a true target. The gradients of the loss with respect to the matrix of the current parameter W 401 are computed during backpropagation. The optimizer 405 then uses AdamW to update the parameters of the matrix of the current parameter W 401 using the computed gradients 403, moment estimates, and weight decay. Specifically, the key steps of AdamW involve maintaining two moment estimates (first moment estimate corresponding to mean of gradients and a second moment estimate corresponding to uncentered variance of gradients), correcting the bias in the moment estimates, updating 407 the parameter W 409 using the corrected moment estimates, and applying weight decay directly to the weights (c.g., not through the gradient 403). The steps listed above (e.g., minus the initial initialization step) can be repeated for a number of iterations or until the model converges (i.c., the loss stops decreasing). This iterative process helps the matrix-valued parameter W 401 to learn and minimize the loss function, thereby training the model effectively.

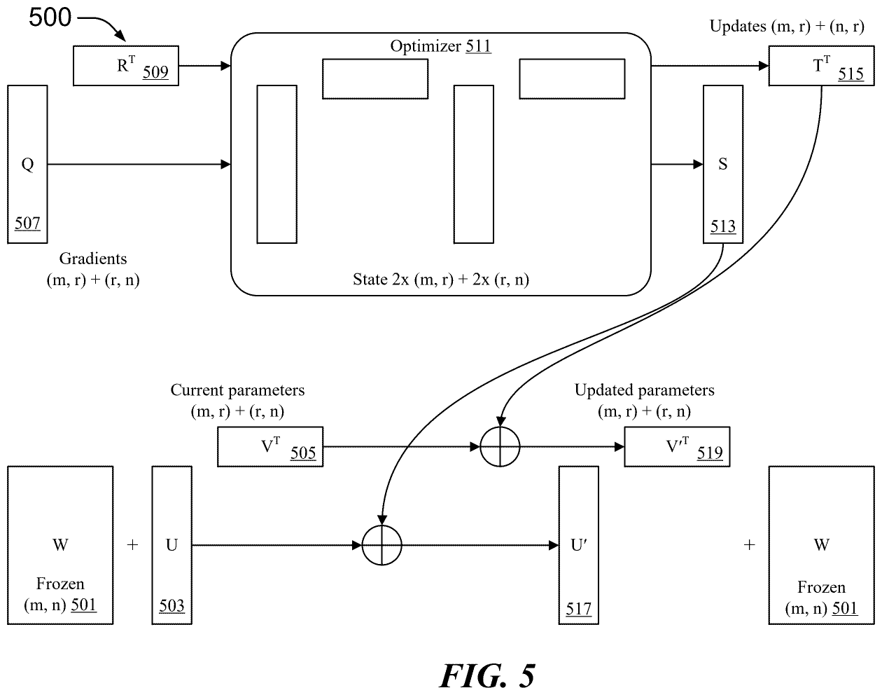

Pre-training large ML models naively requires more memory than is generally offered on most consumer GPUs. Accordingly, the largest ML models must be distributed across multiple data center GPUs. Parameter-efficient fine tuning (PEFT) methods (as will be described below in FIG. 5) have been adapted to reduce the cost of pre-training but sacrifice the quality of the trained model due to modifying how the gradients behave, thus altering the training dynamics.

FIG. 5 illustrates an example of a training iteration for a single matrix-valued parameter using a PEFT technique. Example 500 of FIG. 5 shows a typical training iteration for a single matrix-valued parameter using a PEFT technique such as Low-Rank Adaption (LoRA). LoRa freezes the pretrained model weights and injects trainable rank decomposition matrices into each layer of the Transformer architecture, greatly reduces the number of trainable parameters for downstream tasks. Compared to AdamW as shown in FIG. 4, LoRA may significantly reduce the number of trainable parameters for downstream tasks. In addition, LoRA performs on-par or better than fine-tuning in model quality on several other advanced neural network models designed for NLP tasks (e.g., Robustly optimized BERT approach (ROBERTa), Decoding-enhanced BERT with Disentangled Attention (DeBERTa), Generative Pre-trained Transformer 2 (GPT-2), and GPT-3), despite having fewer trainable parameters, a higher training throughput, and no additional inference latency.

LoRA is a technique used to efficiently fine-tune pre-trained models by learning low-rank updates to the model's weights. When training a single matrix-valued parameter using LoRA in a PEFT framework, the approach involves updating only a small number of parameters while keeping the majority of the pre-trained model weights fixed. This reduces the computational and memory costs of fine-tuning larger models.

As shown in example 500, the fixed pre-trained weight matrix W 501 is used to compute the output. The fixed pre-trained weight matrix W 501, A 503, and B 505 are all used to compute the output, but only the gradients for matrices A 503 and B 505 are computed and only matrices A 503 and B 505 are updated. The optimizer 511 is constructed based on gradients RT 509 and Q 507. The steps (minus the initialization step) is repeated for cach training iteration until the model converges or the desired number of epochs is reached.

LoRA allows training of dense layers in a neural network indirectly, by optimizing rank decomposition matrices of the dense layers' change during adaptation instead, while keeping the pre-trained weights frozen. As shown in example 500 of FIG. 5, the original (m, n) matrix is frozen while explicitly factored low-rank updates are used to reduce the memory required for optimization. As compared to FIG. 4, the trajectory of the product UV^{T} is different than the matrix-valued parameter W 401 from example 400 of FIG. 4. In addition, the product UV^{T} accumulates updates into the frozen full parameters W 501, which still need to be held in memory during training.

LoRA makes training more efficient and lowers the hardware barrier to entry when using adaptive optimizers because there is no need to calculate gradients or maintain the optimizer states for most parameters. Instead, only the injected, much smaller low-rank matrices are optimized. In addition, the design allows a merging of trainable matrices with frozen weights when deployed, which results in no inference latency being introduced.

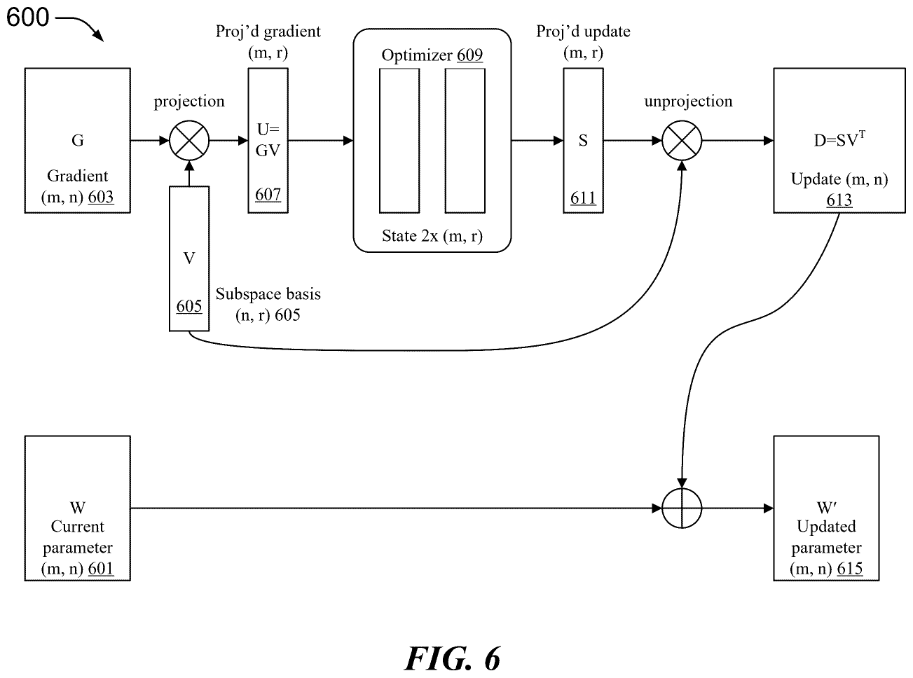

More recently, another method (as will be described in more detail in FIG. 6) showed that it is possible to train large models using extremely compressed optimizer state. In this way, LLaMa-7B pre-training can be fit onto a single high-end consumer GPU while sacrificing very little accuracy in the final model by preserving more similarity of the full-parameter trajectory.

FIG. 6 shows an example of another training iteration for a single matrix-valued parameter using a compressed optimizer state. Example 600 of FIG. 6 shows a typical training iteration for a single matrix-valued parameter using a memory-reduction approach such as a Gradient Low-Rank Projection (GaLore). As compared to example 500 in FIG. 5, example 600 implements a training strategy that allows full-parameter learning and is more memory-efficient than the common low-rank adaption method shown in example 500 of FIG. 5. The key idea is to leverage the slow-changing low-rank structure of the full-sized gradient G 603 of the weight matrix W 601—rather than trying to approximate the weight matrix 601 itself as low rank.

As shown in FIG. 6, example 600 projects gradients into a lower dimensional subspace in which the optimizer 609 operates to reduce the needed memory compared to the training from example 400 of FIG. 4. In addition, using the full-sized gradient G 603 better follows the training trajectory for standard optimization than does the adapted PEFT methods shown in example 500 of FIG. 5. In addition, example 600 also utilizes other methods to reduce the duration that G stays in memory.

First, the process in example 600 begins with an initialization step of starting with a pre-trained weight matrix W 601 and introducing two low-rank matrices 605, 607 such that their product approximates the gradient update to W 601. Typically, the two low-rank matrices 605, 607 are initialized with small random values or zeros. Next, the input is passed through the model and a current weight matrix W 601 is used to compute the output. The loss is computed using a loss function that measures the difference between the predicted output and the true target. The gradient is then calculated by computing the full-sized gradient 603 of the loss with respect to the weight matrix W 601 and decomposing the gradient into low-rank matrices 605, 607. An optimizer 609 is then used to update 611 the low-rank matrices 605, 607. The weight matrix W 601 is then updated 613 to updated parameters 615 using the low-rank approximation. The steps (minus the initialization step) are repeated for each training iteration until the model converges or a specified number of epochs are completed.

By focusing on low-rank approximations of the gradient updates, example 600 aims to reduce the computational complexity and memory usage associated with fine-tuning large models. This makes it a practical and efficient approach for adapting pre-trained models to specific tasks or domains.

However, since example 600 keeps a full-sized gradient 603 and full-sized parameter 601, there may be more efficient ways to represent the parameter such that there may be further reduction in memory cost of that piece.

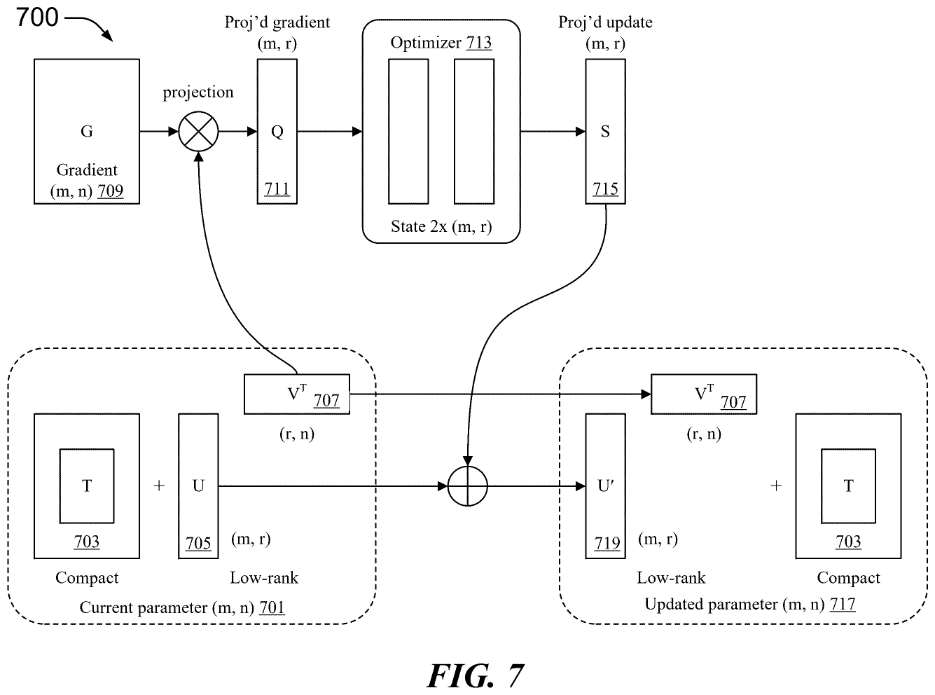

FIG. 7 illustrates an example of a training iteration for a single matrix-valued parameter using tensor networks in accordance with aspects of this disclosure. Example 700 of FIG. 7 shows a typical training iteration for a single matrix-valued parameter that reduces optimizer state memory during training while keeping parameters at their original size.

The present disclosure uses tensor networks (TN) to allow for cheaper pre-training as compared to conventional methods. Specifically, the weight matrices 701, 717 can be cast as TTOs to yield much lower memory and compute footprint of the parameters. In addition, since the TTO geometry has a natural translation onto quantum circuits, inference can be performed in part on a quantum computer (e.g., the QIP system 200 in FIG. 2).

Example 700 shows an optimization using a type of matrix T+U×V^{T}. Tis a TTO low bond-dimension representing a matrix with dimensions m×n. In addition, the quantity T+U×V^{T} is of a shape with a dimension of m×n and is treated as a parameter for the sake of backpropagation to produce the full gradient G. For example, instead of treating the T 703, the low-rank factors 705, and V^{T} 707 as their own parameters and finding the gradients of each of them individually, example 700 treats the sum of the T 703, the low-rank factors 705, and V^{T} 707 as a parameter and find the gradients as the entire sum of the T 703, the low-rank factors 705, and V^{T} 707 (e.g., an intermediate object) as a being the full-sized gradient G 709. V^{T} is an orthogonal basis for a subspace in which optimization is being performed. This allows the dynamics to better match those of standard optimization, while reducing both the parameter and optimizer memory.

In other words, the low-rank factor V^{T} 707 is being used as a projection for the full-sized gradient 709 to reduce the amount of memory taken up by the optimizer 713. In addition, the low-rank factor V^{T} 707 is being treated as part of the current parameter 701 (rather than the as part of the optimizer in example 600 of FIG. 6) such that the product of the low-rank factors U 705 and V^{T} 707 is also part of the bigger representation of the current parameter 701. The rest of the parameter 701 can be compactly represented in T 703. In some examples, there may be other reduced/structured representations for T 703 such as, but not limited to: quantized data types, low-rank structure, or sparse data in order to achieve compactness. For example, T may be a TTO with low bond dimension representing fewer parameters than representing the parameter in the original grid size.

In addition, as shown in FIG. 7, example 700 projects a full gradient G 709 into a lower dimensional subspace 711 in which the optimizer 713 operates to reduce the needed memory as compared to the training from example 400 of FIG. 4. In addition, using the full-sized gradient G 709 better follows the training trajectory for standard optimization than does the adapted PEFT methods shown in example 500 of FIG. 5.

The updated parameter 717 is updated based at least in part on using the optimizer 713 to project the update 715 and using the full-sized gradient G 709 computed by the low-rank factor V^{T} 707 and computing U′ 719 based on the low-rank factor U 705 from the current parameter 701.

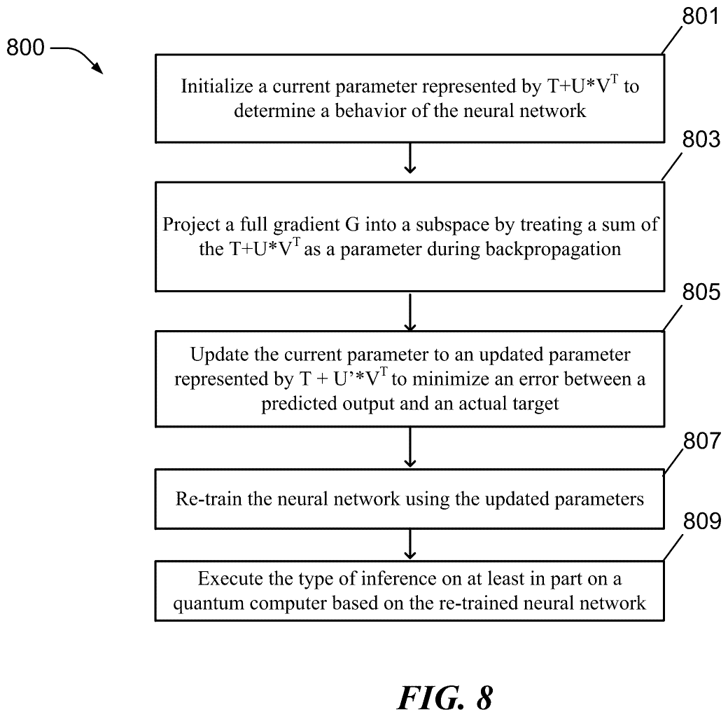

FIG. 8 illustrates a pretraining method for neural networks to execute a type of inference using tensor networks in accordance with aspects of this disclosure. In general, it is noted that parts of the exemplary method 800 can be implemented using the components and systems described herein, especially with request to QIP system 200 and general controller 205 of FIG. 2 as described above and with respect to QIP system 900 as described below. The steps and algorithms described in relation to method 800 may be executed by processor 310 using algorithms components 210. Specifically, the method 800 in FIG. 8 describes a pre-training method that reduces optimizer state memory requirements during training while keeping the parameters at their original size.

At step 801, the method 800 may include initializing a current parameter represented by T+U×V^{T} to determine a behavior of the neural network. The T may be a reduced structured representation of the current parameter. A reduced structured representation means that the T is a simplified or compressed version of the full parameter matric, while still preserving certain structural or meaningful properties that are important for the performance and/or interpretability of the model. In other words, rather than representing the entire parameter directly, T may capture essential information in a more efficient form (e.g., through methods such as low-rank approximation, sparsity, or imposing structural constraints like symmetry or block-diagonal patterns). This reduction helps minimize computational and storage costs while retaining critical properties of the original parameter.

The U may be a low-rank factor corresponding to a representation of a first portion of the current parameter with a dimension of m×r, and the V^{T} may be a low-rank factor corresponding to a representation of a second portion of the current parameter with a dimension of r×n. In other words, V^{T} is an orthogonal basis for a subspace in which optimization is being performed. Here, low-rank refers to the property of the matrices U and V^{T}, which are used to approximate a portion of the full parameter matrix in a more compact and computationally efficient manner. Specifically, a matrix is considered low-rank when its rank (i.c., the number of lincarly independent rows or columns) is significantly less than its maximum possible rank. Specifically, U is a low-rank factor with dimensions m×r, and V^{T} is a low-rank factor with dimensions r×n, where r is substantially smaller than m and n. This dimensionality reduction allows the product U×V^{T} to approximate a full m×n matrix using far fewer parameters, which can substantially reduce the computational complexity and memory requirements associated with training and inference in neural networks. Moreover, by expressing part of the parameter space in a low-rank form, the method 800 enables optimization to be performed within a lower-dimensional subspace, which may improve generalization, training stability, and convergence efficiency. In some implementations, the matrix V^{T} may further be structured to serve as an orthogonal basis, thereby facilitating more effective optimization in the constrained subspace defined by the low-rank factors.

In some examples, a quantity of T+U×V^{T} may correspond to a dimension of m×n.

As an example, referring back to FIG. 7, example 700 shows a current parameter (m, n) 701 being represented by a compact T 703 and low-rank factors 705 and 707.

In some examples, the T may correspond to a quantized data type, low-rank structure, or sparse data to achieve compactness by reducing an amount of data needed to keep around in order to represent a bigger fuller matrix. First, quantized data type may use lower number of bits (e.g., low precision) and quantize each individual number within the current parameter W to obtain a quantized version of it. Second, low-rank structure may be approximated using low-rank factors. Third, sparse data may be used by zeroing out different values.

In some examples, the T is a tensor train operator (TTO) with a low bond-dimension representing a m×n matrix. In some examples, the TTO may be executed on a GPU. In some examples, the TTO may be executed on a QPU and projecting the full gradient G is executed on a GPU. As an example, referring back to FIG. 2, the TTO may be executed on a QIP system 200.

In some examples, the V^{T} may be part of the current parameter and not part of the optimizer. As an example, referring back to FIG. 7, the low-rank factor V^{T} 707 is being treated as part of the current parameter 701 (rather than the as part of the optimizer in example 600 of FIG. 6) such that the product of the low-rank factors U 705 and V^{T} 707 is also part of the bigger representation of the current parameter 701.

At step 803, the method 800 may include projecting a full gradient G into a subspace by treating a sum of T+U×V^{T} as a parameter during backpropagation. In this context, backpropagation refers to the process by which gradients of a loss function with respect to model parameters are computed and used to update those parameters during training. This subspace may have a dimension of m×r, which is smaller than that of the full gradient G, thereby reducing memory and computational overhead. In some examples, the subspace is a lower dimension than the full gradient G. The projection is performed by recognizing that updates to the parameter occur within the span defined by the low-rank structure (i.c., through modifications to U and V^{T}), rather than updating the full matrix directly. As an examples, referring back to FIG. 7, example 700 shows a projection of a full-sized gradient G 709 into a lower dimensional subspace 711 in which the optimizer 713 operates to reduce the needed memory as compared to the training from example 400 of FIG. 4. In addition, using the full-sized gradient G 709 better follows the training trajectory for standard optimization than does the adapted PEFT methods shown in example 500 of FIG. 5.

Optionally, the method may include projecting the full gradient G into the lower dimensional subspace using the V^{T}. In this way, the amount of memory taken up by the optimizer may be reduced.

In some examples, the full gradient G may correspond to a dimension of m×n. As an example, referring back to FIG. 7, the low-rank factor V^{T} 707 is being used as a projection for the full-sized gradient G 709 to reduce the amount of memory taken up by the optimizer 713.

At step 805, the method 800 may include updating the current parameter to an updated parameter represented by T+U′×V^{T} to minimize an error between a predicted output and an actual target. The U′ may be generated based at least in part on inputting the full gradient G into the optimizer and the U from the current parameter. In some examples, the U′ may be a low-rank factor and corresponds to a dimension of m×r. As an example, referring back to FIG. 7, the updated parameter 717 is updated based at least in part on using the optimizer 713 to project the update 715 and using the full-sized gradient G 709 computed by the low-rank factor V^{T} 707 and computing the low-rank factor U′ 719 based at least in part on the low-rank factor U 705 from the current parameter 701.

In some examples, the current parameter and the updated parameter may be kept at a same dimension of mx n. As an example, referring back to FIG. 7, the current parameter (m, n) 701 and the updated parameter (m, n) 717 are kept at a same dimension of m×n.

In some examples, the steps of 803 and 805 may be repeated for a plurality of iterations (epochs) over the dataset. Each iteration aims to slightly improve the updated parameter to reduce the overall loss.

At step 807, the method 800 may include re-training the neural network using the updated parameters.

After training, the updated parameters (c.g., weights and biases) are used for making predictions on new, unseen data. The forward propagation step is the same as during training, but without the loss calculation and backpropagation. The neural network uses the final learned parameters to transform the input data through its layers and produce an output.

At step 809, the method 800 may include executing the type of inference on at least in part on a quantum computer based on the re-trained neural network. The re-trained neural network may be configured according to a parameterization such as T+U×V^{T}, which enables structural decompositions compatible with quantum computation. For example, the underlying TTO or other low-rank geometries of the network may have a natural mapping onto quantum circuits, allowing specific operations (c.g., matrix-vector multiplications, inner products, or transformation steps) to be executed using quantum gates or quantum logic elements. In such implementations, the quantum computer may be used to compute parts of the inference pipeline that benefit from quantum acceleration, such as linear algebraic computations, kernel evaluations, or probability amplitude sampling. In some aspects, the classical components of the system may handle other parts of the inference workflow, including data preprocessing or activation functions that are not efficiently supported on quantum hardware. By distributing inference in this hybrid classical-quantum manner, the method 800 may reduce computational latency or resource usage, particularly in cases where the low-rank or structured parameter representations align well with unitary transformations available in quantum hardware. The re-trained neural network parameters, having been adapted to this decomposition, may thus enable efficient inference in the quantum domain by minimizing circuit depth or gate complexity, while preserving the predictive performance of the model.

This disclosure provides a technique to execute pre-training on a neural network by utilizing tensor networks. Specifically, the present disclosure utilizes a representation of a current parameter by using small core components such as low-rank factors and treats the sum of the small core components as a parameter for the sake of backpropagation to produce a full gradient G. This allows the dynamics to better match those of standard optimization while the parameter and optimizer memory are both reduced. In addition, the weight matrices may be cast as TTOs to yield much lower memory and compute footprint of the parameters. Since the TTO geometry has a natural translation onto quantum circuits, the inference may be performed in part on a quantum computer.

It is understood that the method illustrated by FIG. 8 is exemplary in nature and that the steps described herein may be combined or modified to generate alternative embodiments.

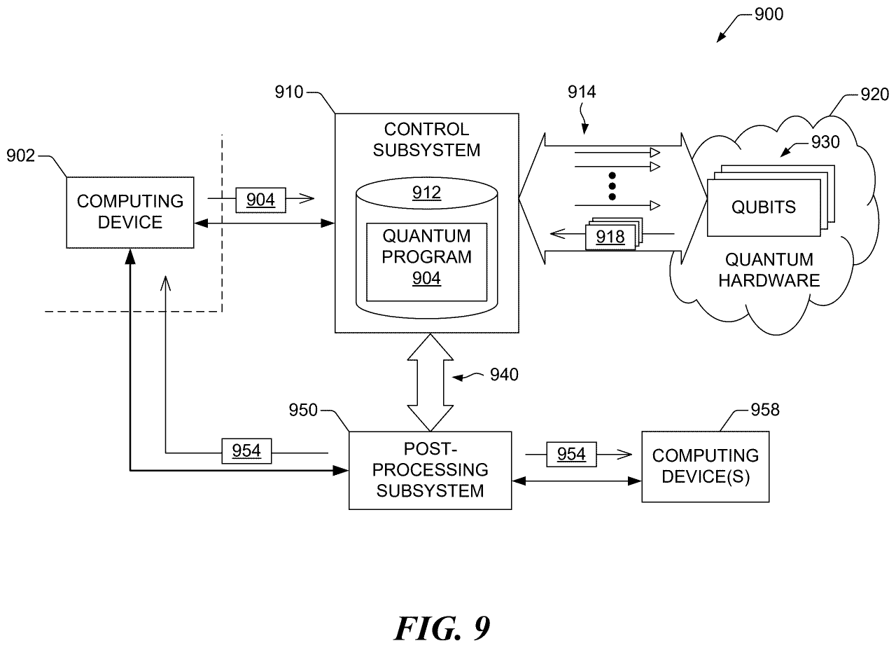

FIG. 9 illustrates an example of a QIP system in accordance with aspects of this disclosure. The example QIP system 900 shown in FIG. 9 includes a control subsystem 910 that can receive a quantum program 904 from a computing device 902 that is remotely located relative to the example QIP system 900 and is functionally coupled (c.g., communicatively coupled) to the control subsystem 910. The computing device 902 can send data defining the quantum program 904 to control subsystem 910 for execution in quantum hardware 920, implementing multi-qubit gates between ion chains trapped in two distinct zones of an ion trap, as described herein. As is indicated by dashed lines, the computing device 902 can be external to the example QIP system 900. For example, the computing device 902 can be a user device (c.g., a classical computer) of an end-user of the QIP system 900. The control subsystem 910 can retain the quantum program 904 in one or more memory devices 912. The quantum program 904 corresponds to a defined quantum computation. The defined quantum computation can be an n-qubit computation, for example. The quantum program 904 can include a quantum circuit (and, in some cases, sub-circuits, such as a parameter component, projection component, training component) representing a quantum algorithm associated with the quantum computation. Examples of the quantum algorithm include a variational quantum algorithm, a machine-learning algorithm, a Fourier transform algorithm, or the like.

The control subsystem 910 can be functionally coupled to quantum hardware 920 via multiple links 914 that permits the exchange of data and/or controls signal between the control subsystem 910 and the quantum hardware 920. The quantum hardware 920 can embody or can include one or more quantum computers. In some cases, the quantum hardware 920 embodies a cloud-based quantum computer. In other cases, the quantum hardware 920 embodies, or includes a local quantum computer. Regardless of its spatial footprint, the quantum hardware 920 includes multiple qubits 930 arranged in a particular layout. Each qubit of the qubits 930 (including the target and ancilla qubits described herein) can be coupled to an environment and/or to one another. Such coupling(s) decoheres and relaxes quantum information contained in the qubit. Thus, the quantum hardware 920 can be noisy. The type of the multiple links can be based on the type of qubits 930 used by the quantum hardware 920 for computation. In some cases, the multiple links 914 can include wireline links or optical links, or a combination of both. In other cases, the multiple links 914 can include microwave resonator devices or microwave transmission lines, or a combination of both.

The qubits 930 can include atomic qubits assembled in an atom-trap. Thus, the atomic qubits can be referred to as trapped-atom qubits. In some cases, each one of the atomic qubits can be a neutral atom. In other cases, each one of the atomic qubits can be an ion, such as an Ytterbium ion, a calcium ion, or similar ions. The atomic-qubits in such cases can be confined within an ion-trap (c.g., the trap 270 (FIG. 2) and can be assembled in a linear arrangement (such as the linear crystal or chain 110 (FIG. 1)). In other implementations, the qubits 930 can include solid-state devices of one of several types. Such devices can be embodied in, for example, Josephson junction devices, semiconductor quantum-dots, or defects in a semiconductor material (such as vacancies in Si and Ge, or nitrogen-vacancy centers in diamond).

The control subsystem 910 can cause the quantum hardware 920 to execute the quantum circuit and/or sub-circuits as described herein. In response, the control subsystem 910 can receive measurement data 918 indicative of computation outputs that includes the output of updated parameters, for example. Because the quantum computation can be performed in two or more qubits, a measurement outcome can be represented as a bitstring representing a particular target output state given a particular set of qubits involved in a quantum computation. The control subsystem 910 can supply at least a portion of the measurement data 918 to components of the control subsystem 910 and/or other subsystems (e.g., post-processing subsystem 950).

The control subsystem 910 also can be functionally coupled to a post-processing subsystem 950 via a communication architecture 940. The communication architecture 940 can include wirelines links, wireless links, network devices (such as gateway devices, servers, and the like), or a combination thereof. The post-processing subsystem 950 can apply one or several post-processing techniques to measurement data 918 received from the quantum hardware 920. By applying such techniques, the post-processing subsystem 950 can generate a result 954 of a quantum computation executed by the quantum hardware. The post-processing subsystem 950 can send the result 954 (or data indicative of the result 954) to the computing device 902 and/or other computing device(s) 958. The post-processing subsystem 950 also can cause the computing device 902 to present the result 954 in a particular way. For example, the post-processing subsystem 950 can direct the computing device 902 to present a user interface including the result 954.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

In general, it is noted that the foregoing description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method of pretraining a neural network to execute a type of inference, comprising:
initializing a current parameter represented by T+U×V^{T} to determine a behavior of the neural network, wherein the T is a reduced structured representation of the current parameter, wherein the U is a low-rank factor corresponding to a representation of a first portion of the current parameter with a dimension of m×r, and the V^{T} is a low-rank factor corresponding to a representation of a second portion of the current parameter with a dimension of r×n;
projecting a full gradient G into a subspace by treating a sum of the T+U×V^{T} as a parameter during backpropagation, wherein the subspace corresponds to a dimension of m×r for operating an optimizer;
updating the current parameter to an updated parameter represented by T+U′×V^{T} to minimize an error between a predicted output and an actual target, wherein the U′ is generated based at least in part on inputting the full gradient G into the optimizer and the U from the current parameter;
re-training the neural network using the updated parameters; and
executing the type of inference on at least in part on a quantum computer based on the re-trained neural network.

2. The method of claim 1, wherein the T is a tensor train operator (TTO) with a low bond-dimension representing a m×n matrix.

3. The method of claim 2, wherein the TTO is executed on a graphics processing unit (GPU).

4. The method of claim 2, wherein the TTO is executed on a quantum processing unit (QPU) and projecting the full gradient G is executed on a GPU.

5. The method of claim 1, wherein the T corresponds to a quantized data type, low-rank structure, or sparse data to achieve compactness.

6. The method of claim 1, wherein the subspace is a lower dimension than the full gradient G.

7. The method of claim 1, further comprising:
initializing the current parameter on a QPU.

8. The method of claim 1, further comprising:
projecting the full gradient G into the subspace using the V^{T}.

9. The method of claim 1, wherein the V^{T} is part of the current parameter and not part of the optimizer.

10. The method of claim 1, wherein the full gradient G corresponds to a dimension of m×n.

11. The method of claim 1, wherein the current parameter and the updated parameter are kept at a same dimension of m×n.

12. The method of claim 1, wherein the U′ is a low-rank factor and corresponds to a dimension of m×r.

13. A system of pretraining a neural network to execute a type of inference, comprising:
at least one processor; and
a memory including instructions that, when executed by the at least one processor, cause the system to:
initialize a current parameter represented by T+U×V^{T} to determine a behavior of the neural network, wherein the T is a reduced structured representation of the current parameter, wherein the U is a low-rank factor corresponding to a representation of a first portion of the current parameter with a dimension of m×r, and the V^{T} is a low-rank factor corresponding to a representation of a second portion of the current parameter with a dimension of r×n;
project a full gradient G into a subspace by treating a sum of the T+U×V^{T} as a parameter during backpropagation, wherein the subspace corresponds to a dimension of m×r for operating an optimizer;
update the current parameter to an updated parameter represented by T+U′×V^{T} to minimize an error between a predicted output and an actual target, wherein the U′ is generated based at least in part on inputting the full gradient G into the optimizer and the U from the current parameter;
re-train the neural network using the updated parameters
execute the type of inference on at least in part on a quantum computer based on the re-trained neural network.

14. The system of claim 13, wherein the T is a tensor train operator (TTO) with a low bond-dimension representing a m×n matrix.

15. The system of claim 14, wherein the TTO is executed on a QPU and projecting the full gradient G is executed on a GPU.

16. The system of claim 13, wherein the T corresponds to a quantized data type, low-rank structure, or sparse data to achieve compactness.

17. The system of claim 13, wherein the instructions when executed further cause the system to:
project the full gradient G into the subspace using the V^{T}.

18. The system of claim 13, wherein the V^{T} is part of the current parameter and not part of the optimizer.

19. The system of claim 13, wherein the current parameter and the updated parameter are kept at a same dimension of m×n.

20. The system of claim 13, wherein the U′ is a low-rank factor and corresponds to a dimension of m×r.
